(19) United States
(12) Patent Application Publication
(10) Pub. No.: US 2025/0109043 A1
(43) Pub. Date: Apr. 3, 2025

(54) SYSTEMS AND METHODS FOR REMOVING DISSOLVED AND SUSPENDED ORGANICS FROM A WATER SOURCE

(71) Applicant: Searen, LLC, Cincinnati, OH (US)

(72) Inventors: Thomas W. Andrews, Cincinnati, OH (US); Emmanuel Briquet, Cincinnati, OH (US)

(21) Appl. No.: 18/905,584

(22) Filed: Oct. 3, 2024

Related U.S. Application Data
(60) Provisional application No. 63/542,216, filed on Oct. 3, 2023.

(51) Int. Cl. C02F 1/00; C02F 1/20; C02F 101/30

(52) U.S. Cl. CPC C02F 1/001; C02F 1/20; C02F 2101/30; C02F 2303/24

(57) ABSTRACT

The present disclosure teaches a method for removing dissolved and suspended organics from a contaminated water source to produce a treated water source. The contaminated water source can be sent through a screening device to produce a coarse solid waste stream and a screened water stream. The coarse solid waste stream can be sent to a water separation device to produce a de-watered solid stream and a liquid stream. The screened water stream can be sent through a vacuum airlift system to produce a foam waste stream and a clean water stream. The foam waste stream can be sent to a defoamer system to produce a gaseous stream and a contaminated liquid stream, wherein the contaminated liquid stream includes dissolved and suspended organics. The clean water stream can then be sent to a polishing system to produce a polished waste water stream and a treated water source.

### CROSS-REFERENCE TO RELATED APPLICATIONS

The present application claims the priority benefit of U.S. Provisional Patent Application Ser. No. 63/542,216, filed Oct. 3, 2023, which is incorporated herein by reference in its entirety.

### TECHNICAL FIELD

Versions of the technology relate, in general, to systems and methods for efficient and effective removal of dissolved and suspended organics from a water source. In particular, versions of the technology relate to the removal of Perfluorinated and Polyfluorinated substances (PFAS) from various water sources.

### BACKGROUND

Perfluorinated and Polyfluorinated substances (PFAS), also known as forever chemicals, are a group of chemicals used to make fluoropolymer coatings and products that resist heat, oil, stains, grease, and water. PFAS based coatings can be found in a wide variety of products. These chemicals resist degradation in the environment and have been determined to be harmful to humans and other organisms.

### BRIEF DESCRIPTION OF THE DRAWINGS

The present disclosure can be more readily understood from a detailed description of some example versions taken in conjunction with the following figures:

FIG. 1 is a schematic illustration of a process for removing contaminants from a water source; and

FIG. 2 is a schematic illustration of a vacuum air lift system contemplated for use within the process shown in FIG. 1.

### DETAILED DESCRIPTION

Various non-limiting versions of the present disclosure can now be described to provide an overall understanding of the principles of the structure, function, and use of the apparatuses, systems, methods, and processes disclosed herein. One or more examples of these non-limiting versions are illustrated in the accompanying drawings. Those of ordinary skill in the art can understand that systems and methods specifically described herein and illustrated in the accompanying drawings are non-limiting versions. The features illustrated or described in connection with one non-limiting version may be combined with the features of other non-limiting versions. Such modifications and variations are intended to be included within the scope of the present disclosure.

Reference throughout the specification to “various versions,” “some versions,” “one version,” “some example versions,” “one example version,” or “a versions” means that a particular feature, structure, or characteristic described in connection with any version is included in at least one version. Thus, appearances of the phrases “in various versions,” “in some versions,” “in one version,” “some example versions,” “one example version,” or “in a versions” in places throughout the specification are not necessarily all referring to the same version. Furthermore, the particular features, structures or characteristics may be combined in any suitable manner in one or more versions.

PFAS chemicals typically exist in low concentrations in various water streams. Frequently, other contaminants are present in the water stream as well. The ideal solution for their removal must: 1) isolate and capture the targeted contaminants to maximize effectiveness and minimize inefficiencies; 2) process large volumes of water efficiently while providing effective separation; 3) ideally need minimal consumables; 4) have a flexible and adaptable approach to accommodate a wide range of waste water streams; and 5) ideally need minimal operation and maintenance activities. Furthermore, known techniques for PFAS removal typically need a large physical footprint, have higher acquisition costs, and consume more energy, thus increasing operating costs.

Described herein are example versions of apparatuses, systems, and methods for removing contaminants in the form of chained or branched carbon compounds, either human-made, naturally occurring, or combinations thereof, such as PFAS, VOCs, hormones, DNA, and/or pathogens from a water source. In one or more versions, system 10 includes a pre-treatment step 12, a primary treatment step 14, and a post-treatment step 16. In one or more versions, the equipment involved in each of the pre-treatment step 12, the primary treatment step 14, and the post-treatment step 16 can be contained within a single building. In other versions, the equipment needed for the sub-step of destruction (discussed in detail below) of each of the pre-treatment step 12, the primary treatment step 14, and the post-treatment step 16 can be performed at a remote location/site which specializing in the destruction processes. In yet other versions, such as a large-scale municipal application, the equipment involved in each of the pre-treatment step 12, the primary treatment step 14, and the post-treatment step 16 can each be contained within a single building for each step (for a total of 3 separate buildings).

The configuration of system 10 can be tailored to the specific needs of the waste water stream entering system 10 in order to optimize efficiency and effectiveness. In general, pre-treatment step 12 begins with a main influent water source 18 entering into a screening device 20. In one or more versions, screening device 20 can be selected from a drum filter, a vibrating screen, a trommel screen, a static screen, a centrifugal screen, a rotary screen, a sieve bend, a bar screen, a grizzly screen, an inclined screen, a dewatering screen, a disc screen, a pressure screen, a curved screen, or combinations thereof. In one or more versions, screening device 20 can be chosen based on the nature and volume of contaminants moving through system 10.

Screening device 20 can separate influent water source 18 into a coarse solid water stream 22 and into a screened influent water stream 24 having less coarse solids than influent water source 18. In one or more versions, coarse solid water stream 22 may only be a small fraction of the overall amount of the influent water source 18 that entered screening device 20, typically from less than 0.1 percent to 5.0 percent of the overall flow, depending on the level of contaminants found in influent water source 18. Coarse water stream 22 can then enter a water separation device 26. In one or more versions, water separation device 26 can be selected from a settler, a belt press, a rotary press, a screw press, a plate and frame filter press, a centrifuge, a decanter centrifuge, a gravity belt thickener, a sedimentation tank, a dissolved air flotation system, a vacuum filter, a hydrocyclone, a gravity thickener, a screw thickener, a static screen, or combinations thereof. In one or more versions, water separation device 26 can be chosen based on the nature and volume of contaminants moving through system 10.

Water separation device 26 can be used to isolate and concentrate solid wastes from coarse water stream 22 for destruction and disposal. Water separation device 26 may provide additional separation of waste from influent water source 18. Water separation device 26 may operate on a smaller volume than screening device 20, so using water separation device 26 that operates at a slower pace than screening device 20 may be usable at this step of the process 10. Water separation device 26 can separate coarse water stream 22 into a de-watered solid stream 28 and a liquid stream 30. Liquid stream 30 can then join with screened influent water stream 24. De-watered solid stream 28 can then enter into a solid destruction device 32 for destruction and disposal of the concentrated solid wastes found within de-watered solid stream 28. In one or more versions, destruction device 32 may utilize chemical destruction, electrical destruction, thermal destruction, or combinations thereof. In one or more versions, destruction device 32 can be an incinerator. In yet other versions, destruction device 32 can be a pyrolysis system, a plasma arc gasification device, a microwave disposal device, a fluidized bed combustion device, a rotary kiln, a high temperature oxidation device, and autoclave, a chemical oxidation device, a chemical reduction device, a chemical precipitation device, a chemical neutralization device, a chemical hydrolysis device, a chemical polymerization device, a chemical dichlorination device, a chemical stabilization device, a chemical digestion device, a chemical leaching control device, a chemical adsorption device, a chemical decontamination device, a plasma arc waste disposal device, an electrochemical waste disposal device, an electrocoagulation device, an electrodialysis device, an electrooxidation device, an electric arc furnace, an electrostatic precipitator, an electroplasma device, a pulsed electronic field device, or combinations thereof. In one or more versions, water destruction device 32 can be chosen based on the nature and volume of contaminants moving through system 10. Which destruction device 32 selected can be selected based on what may be most cost-effective for destroying the contaminants moving through system 10. In one or more versions, destruction device 32 may be a thermal destruction device, chosen because thermal destruction devices are simple, cost-effective, and provide complete mineralization.

As discussed above, liquid stream 30 from water separation device 26 can join screened influent water stream 24, such that both streams are further discussed as being the screened influent water stream 24. Screened influent water stream 24 can enter into primary treatment step 12 by flowing into a vacuum air lift (VAL) system 34. VAL system 34 may extract fine solids, such as suspended and dissolved PFAS and organic materials, and dissolved gases from screened influent water stream 24.

In one or more versions, VAL system 34 can be a plastic, fiberglass, or metal structure approximately 12 to 22 feet tall, for example, that can include a plurality of vertical concentric tubes, such as those shown and described in U.S. Pat. Nos. 10,233,096, 10,618,824, 11,161,756, and U.S. patent application Ser. No. 18/234,658 assigned to Searen, LLC, all of which are hereby incorporated by reference in their entirety. In one example version, bio-film elements can be incorporated into the upflow and/or downflow elements of VAL system 34. In some versions, VAL system 34 can include a fluidic oscillator. In some versions, VAL system 34 can include a flow management system. In one or more versions, VAL system 34 can be operated in a batch or flow-thru mode as desired for the particular influent water source 18. In one or more versions, VAL system 34 may be operated in series of cascaded with other VAL systems to achieve a higher purity in cleaned water stream 38. In one or more versions, VAL system 34 may be operated in series or cascaded with other VAL systems to achieve a higher concentration of the removal of targeted fine solids from liquid waste stream 44. In one or more versions, VAL system 34 may be effective at removing particles that attach to the rising bubble stream within VAL system 34. Chained particles are effective at attaching to the rising bubble stream because they drape over the bubbles. In one or more versions, contaminants having a carbon chain of 4 or more atoms leads to near 100% removal and contaminants having a carbon chain of 6 or more atoms leads to 100% removal. In one or more embodiments, testing at the Environmental Protection Agency (EPA) Test and Evaluation Facility has demonstrated VAL system 34 can remove PFAS from contaminated water to below newly EPA mandated Maximum Contaminant Levels (MCL).

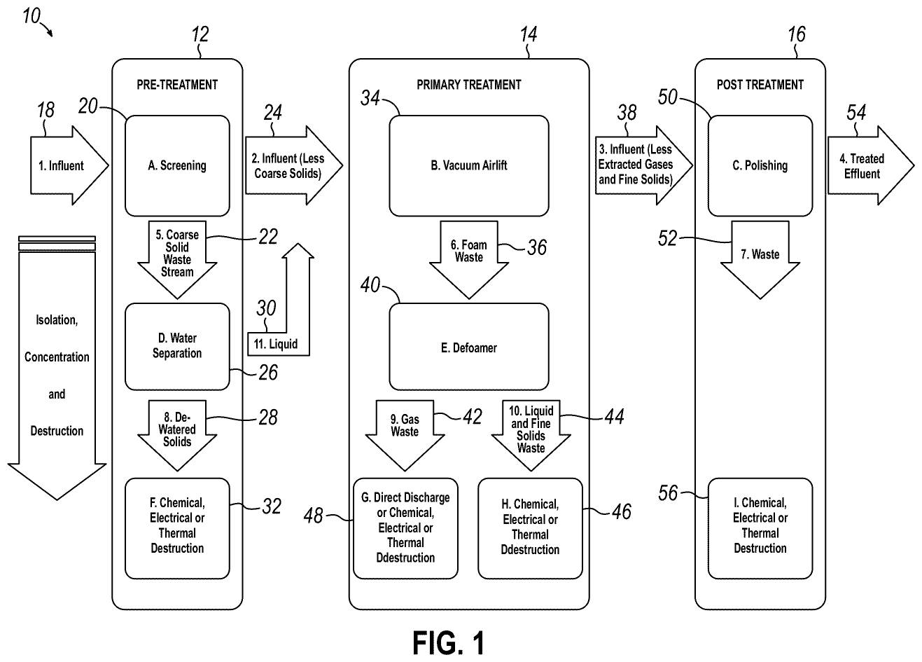

VAL system 34 may separate screened influent water stream 24 into a foam waste stream 36 and into a cleaned water stream 38. Foam waste stream 36 can include captured suspended solids (PFAS) and the extracted dissolved gases from screened influent water stream 24. Foam waste stream 36 can be a small fraction of the overall flow of influent water source 18. In one or more versions, foam waste stream 36 can include from less than 0.1 percent to 5.0% of the overall flow of influent water source 18, depending on the level of contaminants in influent water source 18. Although not shown in FIG. 1, it can be contemplated that in some versions, a surfactant can be added to foam waste stream 36 to increase the level of foaming of foam waste stream 36, which may assist with increasing PFAS removal.

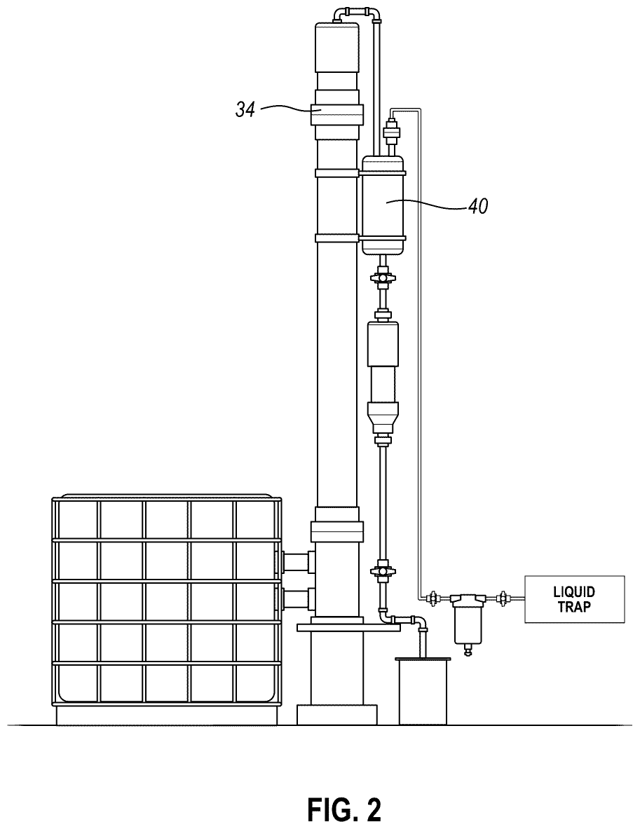

Foam waste stream 36 can then be passed through a defoaming device 40 that separates foam waste stream 36 into a gaseous stream 42 and a contaminated liquid stream 44. An example of a VAL system 34 and a defoaming device 40 is shown in FIG. 2. Contaminated liquid stream 44 may contain the materials targeted by system 10, namely the targeted fine solids, such as PFAS. Contaminated liquid stream 44 can then be passed through to a destruction device 46 to destroy the targeted fine solid, such as PFAS. In one or more versions, destruction device 46 can utilize chemical destruction, electrical destruction, or thermal destruction. In one or more versions, destruction device 46 can be an incinerator. In yet other versions, destruction device 46 can be a pyrolysis system, a plasma arc gasification device, a microwave disposal device, a fluidized bed combustion device, a rotary kiln, a high temperature oxidation device, and autoclave, a chemical oxidation device, a chemical reduction device, a chemical precipitation device, a chemical neutralization device, a chemical hydrolysis device, a chemical polymerization device, a chemical dichlorination device, a chemical stabilization device, a chemical digestion device, a chemical leaching control device, a chemical adsorption device, a chemical decontamination device, a plasma arc waste disposal device, an electrochemical waste disposal device, an electrocoagulation device, an electrodialysis device, an electrooxidation device, an electric arc furnace, an electrostatic precipitator, an electroplasma device, a pulsed electronic field device, or combinations thereof.

Gaseous stream 42 can then either be discharged, as it may be likely that gaseous stream 42 contains no contaminants. However, gaseous stream 42 can also be routed into a destruction device 48 to destroy any contaminants that remain in the stream. In one or more versions, destruction device 48 may utilize chemical destruction, electrical destruction, or thermal destruction. In one or more versions, destruction device 48 can be an incinerator. In yet other versions, destruction device 48 can be a pyrolysis system, a plasma arc gasification device, a microwave disposal device, a fluidized bed combustion device, a rotary kiln, a high temperature oxidation device, and autoclave, a chemical oxidation device, a chemical reduction device, a chemical precipitation device, a chemical neutralization device, a chemical hydrolysis device, a chemical polymerization device, a chemical dichlorination device, a chemical stabilization device, a chemical digestion device, a chemical leaching control device, a chemical adsorption device, a chemical decontamination device, a plasma arc waste disposal device, an electrochemical waste disposal device, an electrocoagulation device, an electrodialysis device, an electrooxidation device, an electric arc furnace, an electrostatic precipitator, an electroplasma device, a pulsed electronic field device, or combinations thereof.

Cleaned water stream 38 can then be routed into post-treatment step 16 of method 10. Specifically, cleaned water stream 38 can be sent to a polishing system 50. Polishing system 50 can be utilized for trace contaminant removal for use in high purity applications. In one or more versions, polishing system 50 can be a granular activated carbon system, an ion-exchange system, a nano-filtration system, a reverse osmosis filtration system, or combinations thereof. However, since it may be likely that most of the contaminants are removed by VAL system 34, the burden and operating costs associated with running polishing system 50 may be greatly reduced.

Polishing system 50 can produce a polished waste water stream 52 and a treated water stream 54. In one or more versions, polished waste water stream 52 may consist of discharge from a reverse osmosis system if a reverse osmosis system is utilized as polishing system 50. In one or more versions, polished waste water stream 52 may consist of contaminated granular activated carbon if a granular activated carbon system is utilized as polishing system 50. If a granular activated carbon system is utilized, in one or more embodiments the granular activated carbon can be recycled by heating it to drive out the contaminants which can then be destroyed, and the rejuvenated or regenerated granular activated carbon can be returned to service. Polished waste water stream 52 can then be sent to a destruction device 56 to destroy any contaminants. In one or more versions, destruction device 56 can utilize a chemical destruction, electrical destruction, or thermal destruction. In one or more versions, destruction device 56 can be an incinerator. In yet other versions, destruction device 56 can be a pyrolysis system, plasma arc gasification, microwave disposal, fluidized bed combustion, rotary kilns, high temperature oxidation, autoclaves, chemical oxidation, chemical reduction, chemical precipitation, chemical neutralization, chemical hydrolysis, chemical polymerization, chemical dichlorination, chemical stabilization, chemical digestion, chemical leaching control, chemical adsorption, chemical decontamination, plasma arc waste disposal, electrochemical waste disposal, electrocoagulation, electrodialysis, electrooxidation, electric arc furnaces, electrostatic precipitators, electroplasma, pulsed electric field technology, or combinations thereof.

The previous steps of method 10 discussed above may have removed the vast majority of the contaminants originally found in influent water source 18, which may greatly reduce the capacity of polishing filtration. In one or more versions, treated water stream 54 can be a highly purified water source. In one or more versions, treated water stream 54 may provide a constant source of treated water for the growth of organisms or as potable water for human consumption.

Numerous advantages can be associated with system 10 of the present disclosure. Such advantages include a reduced energy consumption, a smaller footprint yielding improved space efficiency, lower capital costs, reduced facility heat or air-conditioning, reduced facility ventilation requirements, reduced noise generation, a reduced load on the post-treatment of the effluent, a high concentration factor minimizes destruction and disposal costs, high volume capacity of influent into the system, modularity, flexibility, adaptability, reduction of waste streams by 100× or 1000× less than the influent volume, optimization of treatment strategy based on influent characteristics, minimization of contaminants, reduced demand for expensive processes, and the use of VAL system 34 provides airlift pumping which may eliminate the need for a process pump. Further, if a granular activated carbon system is utilized as the polishing system, by utilizing VAL system 34 prior to the water stream entering the polishing system, VAL system 34 can remove longer chain PFAS compounds which preferentially load granular activated carbon filters at the expense of short chain PFAS compounds which leads to early breakthrough and the need for frequent replacement of the granular activated carbon.

In general, it can be apparent to one of ordinary skill in the art that at least some of the versions described herein can be implemented in many different versions of software, firmware, and/or hardware. The software and firmware code can be executed by a processor or any other similar computing device. The software code or specialized control hardware that can be used to implement versions is not limiting. For example, versions described herein can be implemented by computer software using any suitable computer software language type, using, for example, conventional or object-oriented techniques. Such software can be stored on any type of suitable computer-readable medium or media, such as, for example, a magnetic or optical storage medium. The operation and behavior of the versions can be described without specific reference to specific software code or specialized hardware components. The absence of such specific references is feasible, because it is clearly understood that artisans of ordinary skill would be able to design software and control hardware to implement the versions based on the present description with no more than reasonable effort and without undue experimentation. Moreover, the processes described herein can be executed by programmable equipment, such as computers or computer systems and/or processors. Software that can cause programmable equipment to execute processes can be stored in any storage device, such as, for example, a computer system (nonvolatile) memory, an optical disk, magnetic tape, or magnetic disk. Furthermore, at least some of the processes can be programmed when the computer system is manufactured or stored on several types of computer-readable media.

In various versions disclosed herein, a single component can be replaced by multiple components and multiple components can be replaced by a single component to perform a given function or functions. Except where such substitution would not be operative, such substitution is within the intended scope of the versions.

While FIG. 1 shows aspects of a flow diagram, it can be appreciated that the logic flow merely provides an exemplary implementation of the general functionality. Further, the logic flow does not necessarily have to be executed in the order presented unless otherwise indicated. In addition, the logic flow can be implemented by a hardware element, a software element executed by a computer, a firmware element embedded in hardware, or any combination thereof.

### EXAMPLES

### Example 1

A method of removing dissolved and suspended organics from water comprising passing a contaminated water source through a screening device to produce a coarse solid waste stream and a screened water stream; passing the coarse solid waste stream through a water separation device to produce a de-watered solid stream and a liquid stream; passing the screened water stream through a vacuum airlift system to produce a foam waste stream and a cleaned water stream; passing the foam waste stream through a defoamer system to produce a gaseous stream and a contaminated liquid stream, wherein the contaminated liquid stream includes dissolved and suspended organics; and passing the cleaned water stream through a polishing system to produce a polished waste water stream and a treated water source.

### Example 2

The method of Example 1, wherein the screening device is selected from a drum filter, a vibrating screen, a trommel screen, a static screen, a centrifugal screen, a rotary screen, a sieve bend, a bar screen, a grizzly screen, an inclined screen, a dewatering screen, a disc screen, a pressure screen, a curved screen, or combinations thereof.

### Example 3

The method of Example 1, wherein the coarse solid waste stream includes between 0.1 percent and 5.0 percent of an amount of the contaminated water source that passed through the screening device.

### Example 4

The method of Example 1, wherein the water separation device is selected from a settler, a belt press, a rotary press, a screw press, a plate and frame filter press, a centrifuge, a decanter centrifuge, a gravity belt thickener, a sedimentation tank, a dissolved air flotation system, a vacuum filter, a hydrocyclone, a gravity thickener, a screw thickener, a static screen, or combinations thereof.

### Example 5

The method of Example 1, wherein the screening device operates at a first pace, the water separation device operates at a second pace, and wherein the second pace is slower than the first pace.

### Example 6

The method of Example 1, further comprising wherein the de-watered solid stream passes into a solid destruction device for destruction and disposal of concentrated solid wastes found within the de-watered solid stream.

### Example 7

The method of Example 6, wherein the solid destruction device utilizes chemical destruction, electrical destruction, thermal destruction, or combinations thereof.

### Example 8

The method of Example 6, wherein the solid destruction device is an incinerator, a pyrolysis system, a plasma arc gasification device, a microwave disposal device, a fluidized bed combustion device, a rotary kiln, a high temperature oxidation device, and autoclave, a chemical oxidation device, a chemical reduction device, a chemical precipitation device, a chemical neutralization device, a chemical hydrolysis device, a chemical polymerization device, a chemical dichlorination device, a chemical stabilization device, a chemical digestion device, a chemical leaching control device, a chemical adsorption device, a chemical decontamination device, a plasma arc waste disposal device, an electrochemical waste disposal device, an electrocoagulation device, an electrodialysis device, an electrooxidation device, an electric arc furnace, an electrostatic precipitator, an electroplasma device, a pulsed electronic field device, or combinations thereof.

### Example 9

The method of Example 1, wherein the liquid stream is joined with the screened water stream prior to the screened water stream passing through the vacuum air lift system.

### Example 10

The method of Example 1, wherein the foam waste stream includes between 0.1 percent and 5.0 percent of an amount of the contaminated water source that passed through the screening device.

### Example 11

The method of Example 1, further comprising wherein the gaseous stream is discharged.

### Example 12

The method of Example 1, further comprising wherein the gaseous stream passes to a destruction device to destroy any contaminants in the stream.

### Example 13

The method of Example 11, wherein the destruction device utilizes chemical destruction, electrical destruction, thermal destruction, or combinations there.

### Example 14

The method of Example 11, wherein the destruction device is an incinerator, a pyrolysis system, a plasma arc gasification device, a microwave disposal device, a fluidized bed combustion device, a rotary kiln, a high temperature oxidation device, and autoclave, a chemical oxidation device, a chemical reduction device, a chemical precipitation device, a chemical neutralization device, a chemical hydrolysis device, a chemical polymerization device, a chemical dichlorination device, a chemical stabilization device, a chemical digestion device, a chemical leaching control device, a chemical adsorption device, a chemical decontamination device, a plasma arc waste disposal device, an electrochemical waste disposal device, an electrocoagulation device, an electrodialysis device, an electrooxidation device, an electric arc furnace, an electrostatic precipitator, an electroplasma device, a pulsed electronic field device, or combinations thereof.

### Example 15

The method of Example 1, further comprising wherein the contaminated liquid stream passes to a destruction device to destroy the dissolved and suspended organics.

### Example 16

The method of Example 15, wherein the destruction device utilizes chemical destruction, electrical destruction, thermal destruction, or combinations thereof.

### Example 17

The method of Example 15, wherein the destruction device is an incinerator, a pyrolysis system, a plasma arc gasification device, a microwave disposal device, a fluidized bed combustion device, a rotary kiln, a high temperature oxidation device, and autoclave, a chemical oxidation device, a chemical reduction device, a chemical precipitation device, a chemical neutralization device, a chemical hydrolysis device, a chemical polymerization device, a chemical dichlorination device, a chemical stabilization device, a chemical digestion device, a chemical leaching control device, a chemical adsorption device, a chemical decontamination device, a plasma arc waste disposal device, an electrochemical waste disposal device, an electrocoagulation device, an electrodialysis device, an electrooxidation device, an electric arc furnace, an electrostatic precipitator, an electroplasma device, a pulsed electronic field device, or combinations thereof.

### Example 18

The method of Example 1, wherein the polishing system is a granular activated carbon system, an ion-exchange system, a non-filtration system, a reverse osmosis filtration system, or combinations thereof.

### Example 19

The method of Example 1, wherein the waste water stream passes to a destruction device.

### Example 20

The method of Example 19, wherein the destruction device is an incinerator, a pyrolysis system, a plasma arc gasification device, a microwave disposal device, a fluidized bed combustion device, a rotary kiln, a high temperature oxidation device, and autoclave, a chemical oxidation device, a chemical reduction device, a chemical precipitation device, a chemical neutralization device, a chemical hydrolysis device, a chemical polymerization device, a chemical dichlorination device, a chemical stabilization device, a chemical digestion device, a chemical leaching control device, a chemical adsorption device, a chemical decontamination device, a plasma arc waste disposal device, an electrochemical waste disposal device, an electrocoagulation device, an electrodialysis device, an electrooxidation device, an electric arc furnace, an electrostatic precipitator, an electroplasma device, a pulsed electronic field device, or combinations thereof.

The foregoing description of versions and examples has been presented for purposes of illustration and description. It is not intended to be exhaustive or limiting to the forms described. Numerous modifications are possible in light of the above teachings. Some of those modifications have been discussed, and others can be understood by those skilled in the art. The versions were chosen and described in order to best illustrate principles of various versions as are suited to particular uses contemplated. The scope is, of course, not limited to the examples set forth herein, but can be employed in any number of applications and equivalent devices by those of ordinary skill in the art. Rather it is hereby intended the scope of the disclosure to be defined by the claims appended hereto.

What is claimed is:

1. A method of removing dissolved and suspended organics from water comprising:
a. passing a contaminated water source through a screening device to produce a coarse solid waste stream and a screened water stream;
b. passing the coarse solid waste stream through a water separation device to produce a de-watered solid stream and a liquid stream;
c. passing the screened water stream through a vacuum airlift system to produce a foam waste stream and a cleaned water stream;
d. passing the foam waste stream through a defoamer system to produce a gaseous stream and a contaminated liquid stream, wherein the contaminated liquid stream includes dissolved and suspended organics; and
e. passing the cleaned water stream through a polishing system to produce a waste water stream and a treated water source.

2. The method of claim 1, wherein the screening device is selected from a drum filter, a vibrating screen, a trommel screen, a static screen, a centrifugal screen, a rotary screen, a sieve bend, a bar screen, a grizzly screen, an inclined screen, a dewatering screen, a disc screen, a pressure screen, a curved screen, or combinations thereof.

3. The method of claim 1, wherein the coarse solid waste stream includes between 0.1 percent and 5.0 percent of an amount of the contaminated water source that passed through the screening device.

4. The method of claim 1, wherein the water separation device is selected from a settler, a belt press, a rotary press, a screw press, a plate and frame filter press, a centrifuge, a decanter centrifuge, a gravity belt thickener, a sedimentation tank, a dissolved air flotation system, a vacuum filter, a hydrocyclone, a gravity thickener, a screw thickener, a static screen, or combinations thereof.

5. The method of claim 1, wherein the screening device operates at a first pace, the water separation device operates at a second pace, and wherein the second pace is slower than the first pace.

6. The method of claim 1, further comprising wherein the de-watered solid stream passes into a solid destruction device for destruction and disposal of concentrated solid wastes found within the de-watered solid stream.

7. The method of claim 6, wherein the solid destruction device utilizes chemical destruction, electrical destruction, thermal destruction, or combinations thereof.

8. The method of claim 6, wherein the solid destruction device is an incinerator, a pyrolysis system, a plasma arc gasification device, a microwave disposal device, a fluidized bed combustion device, a rotary kiln, a high temperature oxidation device, and autoclave, a chemical oxidation device, a chemical reduction device, a chemical precipitation device, a chemical neutralization device, a chemical hydrolysis device, a chemical polymerization device, a chemical dichlorination device, a chemical stabilization device, a chemical digestion device, a chemical leaching control device, a chemical adsorption device, a chemical decontamination device, a plasma arc waste disposal device, an electrochemical I waste disposal device, an electrocoagulation device, an electrodialysis device, an electrooxidation device, an electric arc furnace, an electrostatic precipitator, an electroplasma device, a pulsed electronic field device, or combinations thereof.

9. The method of claim 1, wherein the liquid stream is joined with the screened water stream prior to the screened water stream passing through the vacuum air lift system.

10. The method of claim 1, wherein the foam waste stream includes between 0.1 percent and 5.0 percent of an amount of the contaminated water source that passed through the screening device.

11. The method of claim 1, further comprising wherein the gaseous stream is discharged.

12. The method of claim 1, further comprising wherein the gaseous stream passes to a destruction device to destroy any contaminants in the stream.

13. The method of claim 11, wherein the destruction device utilizes chemical destruction, electrical destruction, thermal destruction, or combinations thereof.

14. The method of claim 11, wherein the destruction device is an incinerator, a pyrolysis system, a plasma arc gasification device, a microwave disposal device, a fluidized bed combustion device, a rotary kiln, a high temperature oxidation device, and autoclave, a chemical oxidation device, a chemical reduction device, a chemical precipitation device, a chemical neutralization device, a chemical hydrolysis device, a chemical polymerization device, a chemical dichlorination device, a chemical stabilization device, a chemical digestion device, a chemical leaching control device, a chemical adsorption device, a chemical decontamination device, a plasma arc waste disposal device, an electrochemical waste disposal device, an electrocoagulation device, an electrodialysis device, an electrooxidation device, an electric arc furnace, an electrostatic precipitator, an electroplasma device, a pulsed electronic field device, or combinations thereof.

15. The method of claim 1, further comprising wherein the contaminated liquid stream passes to a destruction device to destroy the dissolved and suspended organics.

16. The method of claim 15, wherein the destruction device utilizes chemical destruction, electrical destruction, thermal destruction, or combinations thereof.

17. The method of claim 15, wherein the destruction device is an incinerator, a pyrolysis system, a plasma arc gasification device, a microwave disposal device, a fluidized bed combustion device, a rotary kiln, a high temperature oxidation device, and autoclave, a chemical oxidation device, a chemical reduction device, a chemical precipitation device, a chemical neutralization device, a chemical hydrolysis device, a chemical polymerization device, a chemical dichlorination device, a chemical stabilization device, a chemical digestion device, a chemical leaching control device, a chemical adsorption device, a chemical decontamination device, a plasma arc waste disposal device, an electrochemical waste disposal device, an electrocoagulation device, an electrodialysis device, an electrooxidation device, an electric arc furnace, an electrostatic precipitator, an electroplasma device, a pulsed electronic field device, or combinations thereof.

18. The method of claim 1, wherein the polishing system is a granular activated carbon system, an ion-exchange system, a non-filtration system, a reverse osmosis filtration system, or combinations thereof.

19. The method of claim 1, further comprising wherein the waste water stream passes to a destruction device.

20. The method of claim 19, wherein the destruction device is an incinerator, a pyrolysis system, a plasma arc gasification device, a microwave disposal device, a fluidized bed combustion device, a rotary kiln, a high temperature oxidation device, and autoclave, a chemical oxidation device, a chemical reduction device, a chemical precipitation device, a chemical neutralization device, a chemical hydrolysis device, a chemical polymerization device, a chemical dichlorination device, a chemical stabilization device, a chemical digestion device, a chemical leaching control device, a chemical adsorption device, a chemical decontamination device, a plasma arc waste disposal device, an electrochemical waste disposal device, an electrocoagulation device, an electrodialysis device, an electrooxidation device, an electric arc furnace, an electrostatic precipitator, an electroplasma device, a pulsed electronic field device, or combinations thereof.
